(19) United States
(12) Patent Application Publication
(10) Pub. No.: US 2011/0252838 A1
(43) Pub. Date: Oct. 20, 2011

(54) HANDLE

(76) Inventor: David Martin Stuckey, Victoria (AU)

(21) Appl. No.: 12/989,986

(22) PCT Filed: May 7, 2009
(86) PCT No.: PCT/AU09/00574

§ 371 Date: Nov. 9, 2010

(30) Foreign Application Priority Data
May 9, 2008 (AU) 2008902265

(51) Int. Cl. E05B 7/00; E05B 67/00; E05B 3/00

(52) U.S. Cl. 70/20; 292/336.3; 16/429

(57) ABSTRACT

A swing handle assembly (500) comprising a swing handle member (510) and a supporting frame (520) therefore where when the handle member substantially contacts the frame, the handle assembly is in a closed condition. The handle member (510) comprises at least an outer surface (511) and two side walls (512), each side wall including an opening (513) therein wherein the openings are substantially aligned to define a passageway (513) through the handle member. The supporting frame (520) bears a capture means (521), which capture means is substantially receivable within the handle member and is in substantial alignment with the passageway therethrough when the handle assembly is in the closed condition, such, that to then place the handle assembly in a locked condition, a separate securing means (900) is able to be passed through the passageway and the capture means.

### FIELD OF THE INVENTION

The present invention relates to a swing handle assembly, comprising a swing handle member and a supporting frame therefor and a capture means. In particular, the capture means is able to cooperate with a separate or independent securing means, which securing means may be selected by the user, to place the handle assembly in a locked condition.

### BACKGROUND OF THE INVENTION

Swing handles have become popular because of their simplicity of function and because they can be made to fit substantially flush against a surface and thereby reduce the likelihood of injury to passers by. Accordingly, swing handles have found wide-spread acceptance as the door handle of choice on access points such as on transport vehicles and the like; housings for computer equipment for which controlled access is desirable; and for where entry is required to a high security area.

In circumstances requiring high security, it is necessary to lock a swing handle in a closed condition. Some previous swing handles incorporate a locking mechanism in the handle member, which mechanism engages with the cooperating supporting frame or door upon which the swing handle assembly is mounted. However, such swing handle assemblies are necessarily sold with the locking mechanism incorporated, potentially limiting the choice of locking means to be used by the end user.

The present invention therefore seeks to provide a lockable swing handle assembly for use with a separate securing means, which securing means can be selected by the user, which assembly seeks to substantially ameliorate or minimize the disadvantages of the prior art.

### SUMMARY OF THE INVENTION

According to the present invention there is provided a swing handle assembly comprising a swing handle member and a supporting frame therefor, whereby when the handle member is in substantial contact with the frame, the handle assembly is in a closed condition, wherein:
(i) the handle member comprises at least an outer surface and two side walls, each side wall including an opening therein wherein the openings are substantially aligned to define a passageway through the handle member; and
(ii) the supporting frame bears a capture means, which capture means is substantially receivable within the handle member and is in substantial alignment with the passageway therethrough when the handle assembly is in the closed condition,
   such that to then place the handle assembly in a locked condition, a separate securing means is able to be passed through the passageway and the capture means.

Preferably, the capture means is a shackle fixed to the support frame. In some forms of the present invention, the capture means is integral with the supporting frame. In other forms of the present invention, the capture means is fixable to the supporting frame via an attachment means. The present invention provides the user with a choice as to which separate securing means is used to lock the swing handle. For example, the end user may choose to use a separate standard key or combination padlock which can be fitted to a swing handle member of the assembly of the present invention to provide the or additional security.

Preferably further, the handle member comprises an open box-like body configuration, wherein the side walls are substantially perpendicularly disposed towards the outer surface, an internal space being defined therebetween, wherein the capture means is substantially receivable within the internal space of the handle member, when the handle assembly is in the closed condition.

In order to reduce the likelihood of causing injury to passers-by, the capture means preferably does not substantially protrude above the outer surface of the swing handle member.

The handle member is preferably of a substantially complementary shape to a recess within the supporting frame to allow the handle member to be receivable within the recess. Preferably further, the recess of the supporting frame is defined by at least one side wants and opposed end walls, wherein the or each side wallis is each provided with a cut-out region which acts to expose the passageway when the handle assembly is in the closed condition. The side walls and end walls also prevent unauthorized opening of the swing handle assembly by a potential intruder by impeding insertion of a lever between the supporting frame and the swing handle member.

As used herein, the term “open condition” refers to the swing handle member being lifted out of contact the supporting frame whereafter the swing handle may be rotated relative to the supporting frame. An example of “open condition” is illustrated in FIG. 1. In contrast, the term “closed condition” refers to the swing handle member being in substantial contact with the supporting frame and more preferably, parallel with the supporting frame and seated substantially in the recess of the supporting frame. That is, the swing handle member is lowered substantially into and substantially received within the supporting frame. An example of “closed condition” is illustrated in FIG. 2.

In certain embodiments of the present invention, the swing handle assembly may further comprise an engagement means, wherein the engagement means releasably engages the swing handle member with the supporting frame when the swing handle assembly is in a closed condition.

The engagement means can be as simple as relying upon a snap- or quick-fit engagement or even magnetic attraction between associated parts or through a friction fit. The snap- or quick-fit engagement means preferably comprises a suitable female member positioned on the floor of the supporting frame or in an alternative embodiment, on the underside of the swing handle member. The snap- or quick-fit engagement means further comprises a male member which is releasably receivable within the suitable female member, and which is located on the underside of the swing handle, or in the above alternative embodiment, on the supporting frame. In a preferred form, when the female member is positioned on the underside of the swing handle member, the position of the cooperating male member is aligned therewith on the supporting frame. However, when the female member is located on the supporting frame, then the male member is aligned with and positioned on the underside of the swing handle member. The male member can be as simple as a threaded fastener having a suitably shaped head. The female member preferably comprises a substantially obconic recess formed within a suitable receiving means and into which recess the male member is able to be releasably received and held. The male member, preferably a threaded fastener, can be releasably secured to the supporting frame. When the female member is positioned on the supporting frame, it can be releasably secured thereto via a suitable fastening means such as a threaded bolt, preferably having a countersunk head, which bolt is receivable within the recess and is thus able to be screwed and held onto the supporting frame.

Instead of the snap- or quick-fit arrangement, one or more, preferably a pair of, suitable magnets may act as engagement means. One or more of these may be provided and affixed to the relevant underside of the swing handle member and as a plate affixed to the floor of the supporting frame. In a friction fit arrangement, the provision of grub rubbers which can be affixed to the inside surface of a chamber and/or to an aligned region on the swing handle member to hold the swing handle member in frictional contact with its supporting frame. The engagement means may incorporate a combination of these preferred arrangements.

As is common with swing handle assemblies, the swing handle member is preferably co-operable with a locking shaft and is pivotal about the locking shaft relative to the supporting frame. Such an arrangement allows the swing handle to be used to rotate devices attached to the locking shaft. Accordingly, such devices may be used to secure doors and the like.

In certain embodiments of the present invention, the swing handle assembly may further include a biasing means acting on the handle member, which biasing means ensures that, unless physically urged downwardly into the supporting frame, the handle member will be urged towards an open condition, that is, the handle member will be in a raised position above the supporting frame. In this way, it will be readily noticeable if the handle member has not been secured to its supporting frame.

The biasing means is preferably located between the locking shaft and the swing handle member, such that when the biasing means is in a relaxed condition, the other end of the swing handle member is maintained substantially out of contact with the supporting frame, enabling an observer to note that the swing handle member is not in lockable engagement with the frame. The biasing meant is preferably a spring, wherein the spring comprises a coiled spring having a first and a second end and a passageway formed through the coil windings thereof.

A benefit derived from such an arrangement is that when the swing handle assembly is in the unlocked condition, the swing handle member will remain in a substantially raised position relative to the frame and will therefore be readily noticeable to the user/observer that the swing handle assembly is not locked and that in the event that the swing handle member is dropped or accidentally let go of, the biasing means acts to substantially prevent the other end of the handle member contacting the area immediately surrounding the supporting frame. In addition, the handle member will remain in the raised position, until positively acted upon by a downward force.

Preferably, downward pressure applied to the outer surface of the swing handle member causes the other end of the handle member to be lowered into the frame, and causes the biasing means to be placed in a substantially compressed condition, whereby the first and second ends of the spring are brought into substantial juxtaposition to one another. Should the applied pressure be removed, the biasing means will return to a substantially relaxed condition, thereby returning the swing handle member to a substantially raised position above the supporting frame and thus above the surrounding area to which the swing handle assembly is attached.

The present handle assembly lends itself to cooperation with a separate securing means such as, but not limited to, a padlock mechanism. The padlock mechanism comprises a lock body member; a lock hasp; and the usual latching mechanism accommodated in the lock body member, as is known in the art. The latching mechanism enables latching of the hasp to the lock body member. The latching mechanism releases at least one end of the hasp on an opening actuation of the latching mechanism, whereby one end of the hasp can be swung away or removed from inside of the lock body member. When being fitted to the swing handle assembly, the unattached hasp end of the padlock can be fed through the aligned capture means and passageway on the swing handle assembly and then latched to the lock body member. Once latched, the swing handle assembly is placed in the locked condition.

In order for the swing handle assembly to be placed in the unlocked condition, at least one end of the hasp is released from the aligned capture means and passageway on the swing handle assembly. Once the padlock bee been disengaged from the swing handle assembly, it is the engagement means of the present invention (if present) that retains the swing handle assembly in a closed condition if a biasing means is present that would otherwise urge the handle member out of substantial contact with the supporting frame and to a substantially raised position thereabove. The handle member may be raised from out of its supporting frame and rotated to open the access point. The skilled addressee will recognize that alternative separate securing means may be employed that function in a manner similar to the padlock described above.

The scope of the present invention further extends to a swing handle assembly as described above being substantially receivable in a dish. The dish, which is substantially the means for mounting the swing handle assembly into or onto the surface of a door, cover or hatch and/or the like, is preferably suitably shaped to at least partially accommodate the swing handle arrangement of the present invention therein. The dish may be suitably configured to also permit at least part of the separate securing means to be accommodated therein. For these purposes, the dish preferably has a pair of opposing side walls. Preferably, each set of side walls extend from and diverge outwardly relative to the dish floor to end in the perimeter flange, which flange is substantially outwardly directed. The depth of the recessed area can be varied such that the height that a padlock mechanism might normally protrude above the mounting surface can be substantially reduced, thereby making it less prone to injuring passers by. The dish is more preferably of a substantially rectangular configuration.

In one preferred embodiment, the dish is formed integral with the supporting frame such that the dish becomes the supporting frame and the swing handle assembly of the present invention is then attached to the dish at a later stage in the manufacturing process. In yet another preferred embodiment, the dish is manufactured separately with the swing handle member and its supporting frame subsequently attached thereto.

### DESCRIPTION OF THE DRAWINGS

Other features and advantages of one or more preferred embodiments of the present invention will be readily apparent to one of ordinary skill in the art from the following written description with reference to, and used in conjunction with, the accompanying drawings. The drawings are directed to one preferred embodiment of a swing handle assembly which has a padlock as its locking mechanism, as follows:

FIG. 1 shows an embodiment of a swing handle assembly, according to the present invention, in an open condition;

FIG. 2 shows the same embodiment as illustrated in FIG, 1 in a closed condition and with a padlock mechanism, in the locked condition, attached thereto;

FIG. 3 shows a cut-away view of an exemplary engagement means, as incorporated in an embodiment of the present invention when in an open condition;

FIG. 4 shows the same embodiment as illustrated in FIG. 3 in a closed condition; and

FIG. 5 shows an embodiment of a swing handle assembly, according to the present invention, recessed in a dish, in a closed condition.

### DETAILED DESCRIPTION OF THE PREFERRED EMBODIMENTS

Referring to all the drawings wherein like reference numerals designate like or corresponding parts throughout the several views, the swing handle assembly 500 includes a swing handle member 510 and a supporting frame 520. As is common to swing handle assemblies, the handle member 510 is co-operable with a locking shaft 530 and is pivotal about the locking shaft relative to the supporting frame 520 via its attachment point 540 thereto.

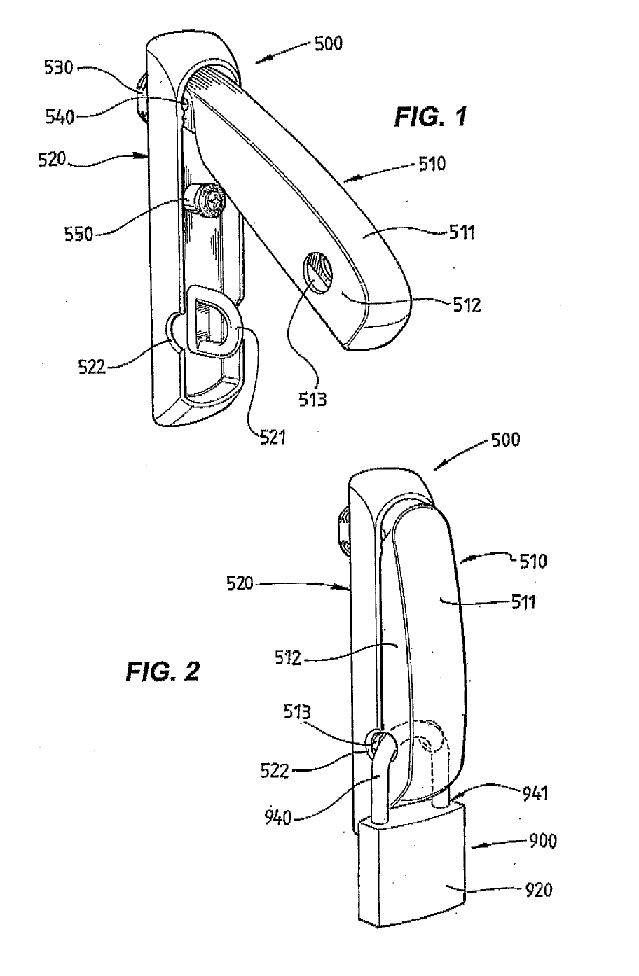

Referring to FIG. 1, the swing handle assembly 500 comprises: (1) a swing handle member 510 having at least an outer surface 511 and two side portions 512 substantially perpendicular to the outer surface 511 defining an internal space, wherein the side portions 512 include openings that define a passageway 513 therethrough; and (ii) a supporting frame 520 bearing a capture means 521, wherein, when the handle assembly 500 is in a closed condition (see FIG. 2), the passageway 513 and the capture means 521 are substantially aligned to permit a separate securing means to be passed through the passageway 513 and capture means 521. When the handle assembly 500 is in a closed condition, the capture means 521 is received within the internal space of the handle member 510 and therefore does not protrude above the outer surface 511 of the handle member 510. The supporting frame 520 may also include cut outs 522 substantially aligned with the capture means 521. The cut outs 522 permit a separate securing means to be passed through the aligned passageway 513 and capture means 521 when the handle member 510 is received within the supporting frame 520 when the handle assembly is in a closed or locked condition.

As illustrated in FIG. 2 by way of Example, the separate securing means may be, but not limited to, a padlock mechanism 900. In this form of the invention, the swing handle assembly 500 comprises a capture means 521 for receiving the padlock mechanism 900. In certain embodiments of the present invention, the capture means 521 may be releasably attachable to the supporting frame 520 of the handle assembly 500 or formed integral with the supporting frame 520. If the capture means is releasably attached to the supporting frame 520, it may be scoured to the supporting frame 520 by way of a fixing means such as a fastener, for example, a bolt. Such a fixing means would be inaccessible from outside the handle assembly 500, when mounted on the door, cover, lid etc. Furthermore, when the handle assembly 520 is in a closed condition, the handle member 510 covers the capture means 521 rendering it inaccessible from outside the handle assembly 520.

The padlock mechanism 900 comprises a lock body 920 containing the usual latching mechanism elements and a lock hasp 940. When one end 941 of the hasp 940 is removed from out of the lock body to enable movement of the hasp 940 to be swung away, the padlock 900 can be removed and separated from the capture means 521. When being fitted to the handle assembly 500, the unattached hasp end 941 of the padlock 900 can be fed through the substantially aligned capture means 521 and passageway 513 on the handle member 510 and then inserted into and latched to the lock body 920. Once latched, the handle assembly 500 is placed in the locked condition.

Once the padlock 900 has been disengaged from the handle assembly 500, the handle member 510 can be raised from out of its supporting frame 520 and rotated to open the access point.

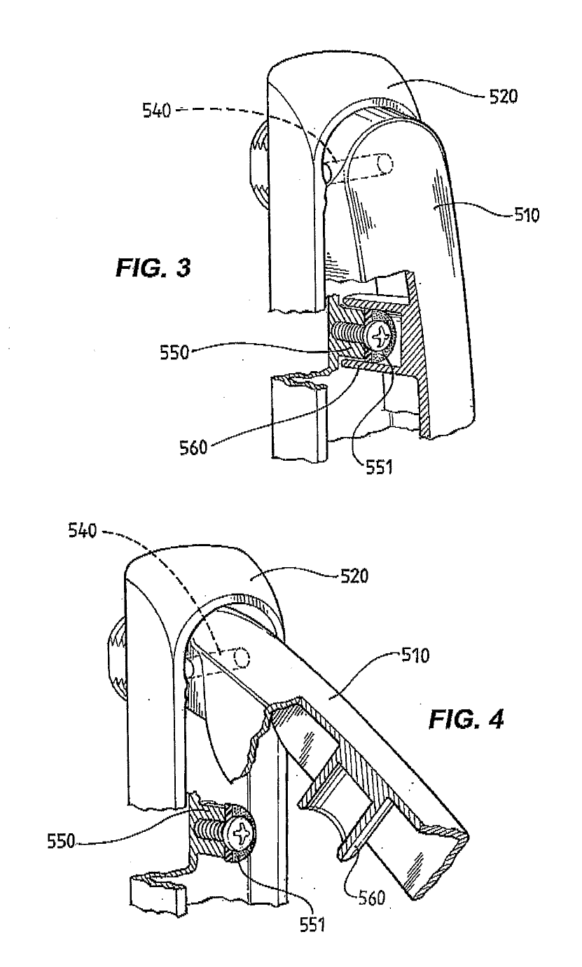

The embodiment of an engagement means illustrated in FIGS. 3 and 4, is a friction fit arrangement. The engagement means comprises a male member 550 which is releasably receivable within the suitably shaped and positioned female member 560. In FIGS. 3 and 4, the male member 550 is positioned on the supporting frame 520, the cooperating female member 560 is aligned thereto and positioned on the underside of the handle member 510. The male member comprises a washer 551 that interacts with the inside of the female member 560 to frictionally hold the swing handle member 510 in contact with its supporting frame 520.

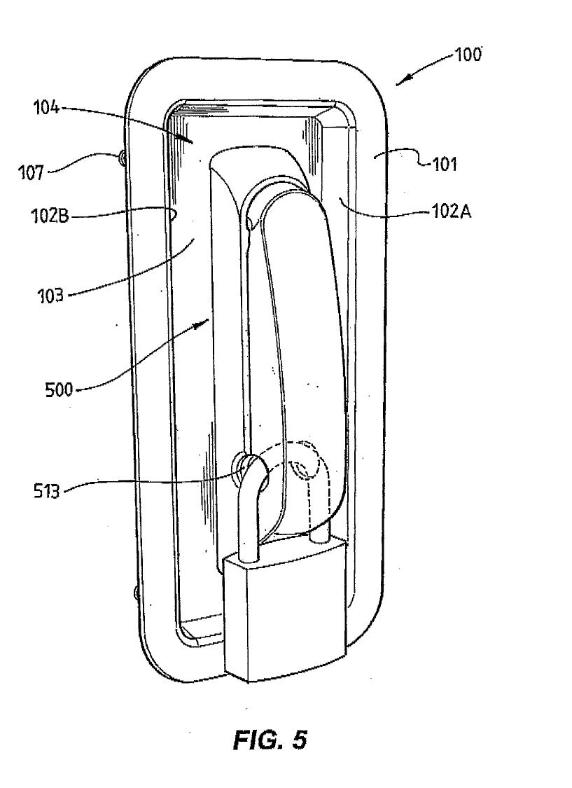

As illustrated in FIG. 5, a swing handle assembly 500 according to the present invention may also be mounted within a dish 100 which comprises a perimeter flange 101, at least one pair of opposing side wall 102A and 102B, a floor 103 and a recessed area 104 formed by the floor 103 and the at least one pair of sidewalls 102 for receiving at least part of a handle assembly 500. There is at least one opening in the dish floor 103 to accommodate locking shaft 530 of the handle assembly 500. The perimeter flange 101 is useful for securing the dish 100 to a door, lid or the like using appropriate fastening means 107. Alternatively, the supporting frame 520 of the handle assembly 500 may be formed integral with the dish 100. This may have the advantage of requiring fewer components to be manufactured and also to reduce the cost of production. Such an embodiment is also intended to be encompassed by the present invention.

The swing handle member 510 is preferably formed with a complementarily shaped passageway 513 therethrough positioned at a suitable location along the length of the handle member 510 to be substantially aligned with the capture means (not shown) when the handle assembly 500 is in a closed condition. The capture means can be received through a second opening in the floor 103 of dish 100 and secured to the underside of dish 100 by attachment means, such as a nut and bolt arrangement.

Where the terms “comprise”, “comprises”, comprised” or “comprising”, “including” or “having” are used in this specification, they are to be interpreted as specifying the presence of the stated features, integers, steps or components referred to, but not to preclude the presence or addition of one or more other feature, integer, step, component or group thereof.

Further, any prior art reference or statement provided in the specification is not to be taken as an admission that such art constitutes, or is to be understood is constituting, part of the common general knowledge.

Those skilled in the art will appreciate that although the invention described herein for simplicity's sake has referred in particular to a swing handle assembly, it has a general applicability to handles in general. It is to be understood that the invention includes all variations and modifications of the features identified, including all types or handles and locks referred to or any two components which are required to be latched together as indicated in the specification individually or collectively and any and all combinations of any two or more of said features.

1. A swing handle assembly comprising a swing handle member and a supporting frame therefor, whereby when the handle member is in substantial contact with the frame, the handle assembly is in a closed condition, wherein:
(i) the handle member comprises at least an outer surface and two side walls, each side wall including an opening therein wherein the openings are substantially aligned to define a passageway through the handle member; and
(ii) the supporting frame bears a capture means, which capture means is substantially receivable within the handle member and is in substantial alignment with the passageway therethrough when the handle assembly is in the closed condition,
such that to then place the handle assembly in a locked condition, a separate securing means is able to be passed through the passageway and the capture means.

2. The swing handle assembly of claim 1, wherein the capture means is a shackle fixed to the support frame.

3. The swing handle assembly of claim 1, wherein the handle member comprises an open box-like body configuration, wherein the side walls are substantially perpendicularly disposed towards the outer surface, an internal space being defined therebetween, wherein the capture means is substantially receivable within the internal space of the handle member, when the handle assembly is in the closed condition.

4. The swing handle assembly of claim 1, wherein the handle member is of a substantially complementary shape to a recess within the supporting frame to allow the handle member to be receivable within the recess.

5. The swing handle assembly of claim 4, wherein the recess of the supporting frame is defined by at least one side wall/s and opposed end walls, wherein the or each side wall/s is each provided with a cut-out region which acts to expose the passageway when the handle assembly is in the closed condition.

6. The swing handle assembly of claim 1, further including an engagement means, whereby the handle member is held in releasable engagement with the supporting frame when the handle assembly is in the closed condition.

7. The swing handle assembly of claim 1, wherein the handle member is pivotally mounted to a locking shaft and a biasing means is located between the handle member and the shaft, wherein the biasing means urges the handle member towards an open condition.

8. The swing handle assembly of claim 1, wherein the handle assembly is mounted in a dish.

9. The swing handle assembly of claim 1, wherein the separate securing means is a padlock.

10. A swing handle assembly including a handle member and a supporting frame, wherein:
a. the handle member:
(1) includes opposing handle side walls with an outer handle surface therebetween, each handle side wall including an opening onto a passageway defined through the handle member;
(2) is pivotally connected with respect to the supporting frame to move between:
i. a closed condition adjacent the frame, and
ii. an open condition spaced from the frame,
b. the supporting frame bears a capture member protruding therefrom, the capture member being configured to be received:
(1) within the handle member between the openings in the handle side walls, and
(2) with an outer portion of the capture member extending:
i. at least partially about the circumference of the passageway, and
ii. between the passageway and the outer handle surface, when the handle assembly is in the closed condition, whereby the handle assembly can be secured in the closed condition by inserting a securing member through the passageway, with the outer portion of the capture member situated between the securing member and the outer handle surface.

11. The swing handle assembly of claim 10 wherein the capture member defines a loop having opposing ends fixed to the supporting frame.

12. The swing handle assembly of claim 10 wherein:
a. the handle member includes
(1) a pivot end at or adjacent to which the handle member is pivotally connected with respect to the supporting frame, and
(2) an opposing outer handle end, between which the handle side walls and outer handle surface extend,
b. an internal space is defined between the handle side walls and outer handle surface, and between the pivot end and the outer handle end, and
c. the capture member is received within the internal space when the handle assembly is in the closed condition.

13. The swing handle assembly of claim 10 wherein the supporting frame includes a recess defined therein, the recess being configured such that the handle member is at least substantially complementarily received therein when the handle assembly is in the closed condition.

14. The swing handle assembly of claim 13 wherein:
a. the recess of the supporting frame is defined between surrounding sidewalls, and
b. the sidewalls have a cutout defined therein, the cutout being aligned with the passageway when the handle assembly is in the closed condition.

15. The swing handle assembly of claim 10 further including an engagement member releasably engaging the handle member to the supporting frame when the handle assembly is in the closed condition.

16. The swing handle assembly of claim 10 further including:
a. a male member on one of the handle member and the supporting frame, and
b. a female receptacle on the other of the handle member and the supporting frame, wherein the female receptacle releasably engages the male member when the handle assembly is in the closed condition.

17. The swing handle assembly of claim 10 further including a locking shaft:
a. fit within the supporting frame, and
b. to which the handle member is pivotally mounted.

18. The swing handle assembly of claim 17 further including a spring situated between the handle member and the shaft, wherein the spring urges the handle member towards an open condition.

19. The swing handle assembly of claim 10 further including a dish having a dish floor situated between dish sidewalls, wherein the supporting frame is mounted on the dish floor.

20. A swing handle assembly including a handle member and a supporting frame, wherein:
a. the handle member includes:
(1) a pivot end pivotally connected with respect to the supporting frame, and an opposing outer handle end;
(2) opposing handle side walls with an outer handle surface therebetween, with the handle side walls and outer handle surface extending between the pivot end and the outer handle end;
(3) an internal space defined between the handle side walls and outer handle surface, and between the pivot end and outer handle end;
(4) a passageway extending between opposing openings defined on the handle side walls, the passageway opening onto the internal space;
b. the supporting frame bears a capture member protruding therefrom, the capture member being capture member defined by a loop having opposing ends fixed to the supporting frame,
wherein the handle member, when pivoted into a closed condition at which the handle member is closest to the supporting frame, receives the capture member within the internal space with the passageway aligned within the loop.
